(19) United States
(12) Patent Application Publication
(10) Pub. No.: US 2025/0383694 A1
(43) Pub. Date: Dec. 18, 2025

(54) FAN CONTROL METHOD AND ELECTRONIC DEVICE

(71) Applicant: Lenovo (Beijing) Limited, Beijing (CN)

(72) Inventors: Hao WANG, Beijing (CN); Zuosen ZHANG, Beijing (CN)

(21) Appl. No.: 19/229,691

(22) Filed: Jun. 5, 2025

(30) Foreign Application Priority Data
Jun. 6, 2024 (CN) 202410730297.0

(51) Int. Cl. G06F 1/20

(52) U.S. Cl. CPC G06F 1/20

(57) ABSTRACT

A fan control method includes determining a target fan that causes a degradation in storage read-write performance of the electronic device based on a relationship between a hard disk and a fan in the electronic device, where the target fan is one or part of all fans; adjusting the actual rotation speed of a to-be-adjusted fan so that characteristic parameters of each component in the electronic device meet a performance benchmark, where the to-be-adjusted fan is determined based on the target fan. The characteristic parameters of each component meeting the performance benchmark include: the temperature of each component meeting the corresponding predefined temperature guideline, and/or, the storage read-write performance of the electronic device meeting the read-write performance benchmark. The referred each component includes a hard disk.

### CROSS-REFERENCE TO RELATED APPLICATION

This application claims priority to Chinese Patent Application No. 202410730297.0, filed on Jun. 6, 2024, the content of which is incorporated herein by reference in its entirety.

### TECHNICAL FIELD

The application generally relates to the field of server technology, and in particular to a fan control method and an electronic device thereof.

### BACKGROUND

As server performance continues to improve, more and more functions are required, and the power consumption of servers is also increasing. When a server works continuously for a long time, the heat inside the server will continue to accumulate, so the fan rotation speed needs to be quickly increased to dissipate heat in time to prevent the corresponding chips and/or hard disk devices from failing or even being damaged due to excessive temperature. It should be noted that the rapid increase in fan rotation speed brings stronger air volume, but also generates higher vibration and noise, which affects the read-write performance of the hard disk device.

### SUMMARY

One aspect of the present disclosure provides a fan control method, and the method includes: based on a relationship between hard disks and fans in an electronic device, determining a target fan that causes a storage read-write performance of the electronic device to degrade; where the target fan is one or part of all fans in the electronic device; and adjusting an actual rotation speed of a to-be-adjusted fan so that characteristic parameters of each component in the electronic device meet a performance benchmark, where the to-be-adjusted fan is determined based on the target fan, where the characteristic parameters of each component meeting the performance benchmark include a temperature of each component meeting a corresponding predefined temperature guideline, and/or a storage read-write performance of the electronic device meeting a read-write performance benchmark, and the each component includes a hard disk.

Another aspect of the present disclosure an electronic device, and the electronic device includes one or more processors and a memory containing a computer program that, when being executed, causes the one or more processors to perform: based on a relationship between hard disks and fans in an electronic device, determining a target fan that causes a storage read-write performance of the electronic device to degrade; where the target fan is one or part of all fans in the electronic device; and adjusting an actual rotation speed of a to-be-adjusted fan so that characteristic parameters of each component in the electronic device meet a performance benchmark, where the to-be-adjusted fan is determined based on the target fan, where the characteristic parameters of each component meeting the performance benchmark include a temperature of each component meeting a corresponding predefined temperature guideline, and/or a storage read-write performance of the electronic device meeting a read-write performance benchmark, and the each component includes a hard disk.

Another aspect of the present disclosure provides a non-transitory computer readable storage medium containing a computer program that, when being executed, causes at least one processor to perform: based on a relationship between hard disks and fans in an electronic device, determining a target fan that causes a storage read-write performance of the electronic device to degrade; where the target fan is one or part of all fans in the electronic device; and adjusting an actual rotation speed of a to-be-adjusted fan so that characteristic parameters of each component in the electronic device meet a performance benchmark, where the to-be-adjusted fan is determined based on the target fan, where the characteristic parameters of each component meeting the performance benchmark include a temperature of each component meeting a corresponding predefined temperature guideline, and/or a storage read-write performance of the electronic device meeting a read-write performance benchmark, and the each component includes a hard disk.

Other features of the present disclosure and advantages thereof will become apparent from the following detailed description of exemplary embodiments of the present disclosure with reference to the accompanying drawings.

### BRIEF DESCRIPTION OF THE DRAWINGS

In order to more clearly illustrate the technical solutions in the embodiments of the disclosure, the drawings essential for understanding the disclosed embodiments will be briefly described below. Apparently, the drawings described below are merely some embodiments of the disclosure. For a person skilled in the art, other drawings may be obtained based on the provided drawings without making creative efforts.

FIG. 1 is a flowchart of a fan control method according to an embodiment of the disclosure;

FIG. 2 is a flowchart of another fan control method according to an embodiment of the disclosure;

FIG. 3 is a flowchart of another fan control method according to an embodiment of the disclosure;

FIG. 4 is a flowchart of another fan control method according to an embodiment of the disclosure;

FIG. 5 is a flowchart of another fan control method according to an embodiment of the disclosure;

FIG. 6 is a schematic structural diagram of a fan control device according to an embodiment of the disclosure; and

FIG. 7 is a schematic structural diagram of an electronic device according to an embodiment of the disclosure.

### DETAILED DESCRIPTION

In order to enable those skilled in the art to better understand the technical solutions of the disclosure, the technical solutions in the embodiments of the disclosure will be clearly and thoroughly described hereinafter in conjunction with the drawings in the embodiments of the disclosure. Apparently, the described embodiments are merely part of the embodiments of the disclosure, not all of the embodiments. Based on the embodiments in the disclosure, all other embodiments obtained by a person skilled in the art without making creative efforts are within the scope of protection of the present disclosure.

The terms “first”, “second”, and the like in the specification and claims of the disclosure and the drawings are used to distinguish different objects, rather than to describe a specific order. In addition, the terms “including” and “comprising” and any variations thereof are intended to cover non-exclusive inclusions. For example, a process, method, system, product or device that includes a series of steps or units is not limited to the listed steps or units, but optionally includes steps or units that are not listed, or optionally includes other steps or units inherent to these processes, methods, systems, products or devices.

Reference to “embodiments” herein means that a particular feature, structure, or characteristic described in conjunction with the embodiments may be included in at least one embodiment of the disclosure. The appearance of the phrase in various locations in the specification does not necessarily refer to the same embodiment, nor is it an independent or alternative embodiment that is mutually exclusive with other embodiments. It is explicitly and implicitly understood by those skilled in the art that the embodiments described herein may be combined with other embodiments.

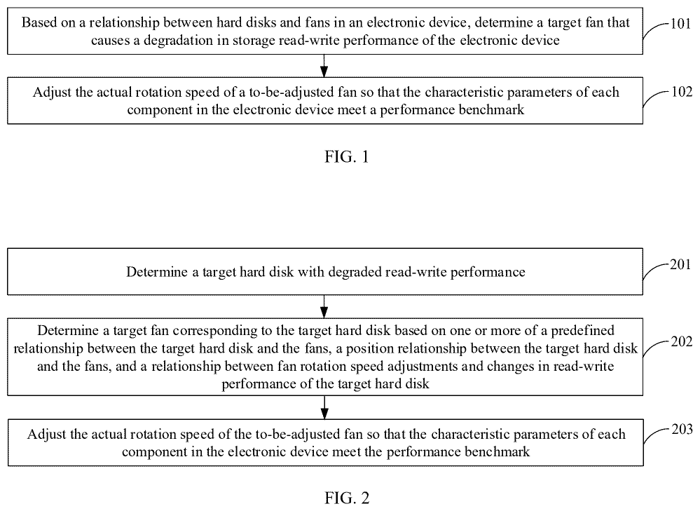

An embodiment of the disclosure provides a fan control method, which is applied to an electronic device. As shown in FIG. 1, the method includes the following steps.

Step 101: Based on a relationship between hard disks and fans in an electronic device, determine a target fan that causes a degradation in storage read-write performance of the electronic device.

The target fan is one or part of all fans.

In the embodiments of the disclosure, the hard disk is the main storage medium of the electronic device, which is configured to store various types of data for a long time, including operating systems, applications, user documents, pictures, videos, music, etc. Whether the electronic device is a personal computer or a server, the hard disk is the core device for storing all data. Here, the hard disk includes but is not limited to a mechanical hard disk (HDD) and a solid state drive (SSD).

In the embodiments of the disclosure, the storage read-write performance of the electronic device is a key indicator for measuring the data processing capability of the electronic device. The storage read-write performance of the electronic device directly affects the response speed, data processing efficiency and overall performance of the electronic device. It should be noted that the electronic device may monitor its own storage read-write performance in real time. For example, the electronic device may add a monitoring channel in a baseboard management controller (BMC) or a web server and other channels to monitor the storage read-write performance of the electronic device in real time. Here, the storage read-write performance of the electronic device may be understood as the read-write performance of the hard disk in the electronic device, where the read-write performance of the hard disk may be determined based on the read-write rate of the hard disk.

In the embodiments of the disclosure, a controlled fan is a control object of the fan control method provided in the embodiments of the disclosure. Based on the fan control method provided in the embodiments of the disclosure, the real-time rotation speed of the controlled fan may be controlled. It should be noted that the controlled fan may be disposed in the chassis of the electronic device, and may be used to dissipate heat for other components disposed in the chassis of the electronic device.

In the embodiments of the disclosure, the relationship between hard disks and fans includes but is not limited to: a predefined relationship between hard disks and fans, a positional relationship between hard disks and fans, and a relationship between the rotation speed adjustment of each fan and change in the read-write performance of the hard disk.

The predefined relationship between hard disks and fans may be a one-to-one predefined relationship between hard disks and fans, or a one-to-many predefined relationship between hard disks and fans.

The positional relationship between hard disks and fans may be determined based on the distance between the hard disk and each fan.

The relationship between the rotation speed adjustment of each fan and the change in the read-write performance of the hard disk may be a relationship in which whether the read-write performance of the hard disk changes is determined based on the rotation speed adjustment of the fan.

In the embodiments of the disclosure, the target fan may be one or some of the fans among all the fans that cause the storage read-write performance of the electronic device to degrade, and the target fan is a fan that causes the read-write performance of the electronic device to degrade, and is determined from among all the fans based on the relationship between hard disks and fans in the electronic device.

In practical applications, the electronic device may be a personal computer or a server with a high-performance system, where the personal computer may include a desktop computer and a laptop computer. The specific type of the electronic device in the embodiments of the disclosure is not limited.

In the embodiments of the disclosure, the degradation of the storage read-write performance of the electronic device may be that the electronic device monitors its overall storage read-write performance in real time to determine the degradation of the overall storage read-write performance. Apparently, the degradation of the storage read-write performance of the electronic device may also be that the electronic device monitors the storage read-write performance of each hard disk in itself in real time to determine the hard disk with the degradation of storage read-write performance, and then determines that the storage read-write performance of the electronic device has been reduced.

In the embodiments of the disclosure, when the electronic device monitors the degradation of its own storage read-write performance in real time, it is necessary to analyze the interaction between hard disks and fans to identify which fan or fans are the problem, thereby affecting the hard disk performance. This involves considering the vibration, noise, and heat dissipation efficiency generated by the fan, because improper fan configuration or problems with the fan itself (e.g., aging, excessive rotation speed, or design defects) may cause the hard disk to work unstably, resulting in an increase in the read-write error rate and a decrease in the data transmission speed. Therefore, determining and optimizing the configuration of a target fan or replacing the problematic fan is a key step in improving the overall performance of the storage system.

Step 102: Adjust the actual rotation speed of the to-be-adjusted fan so that the characteristic parameters of each component in the electronic device meet a performance benchmark.

The to-be-adjusted fan is determined based on the target fan.

Here, the characteristic parameters of each component meeting the performance benchmark includes: the temperature of each component meeting the corresponding predefined temperature guideline, and/or the storage read-write performance of the electronic device meeting the read-write performance benchmark, and each component including a hard disk.

In the embodiments of the disclosure, the to-be-adjusted fan is determined based on the target fan, which may be understood as the to-be-adjusted fan may be the target fan, and the to-be-adjusted fan may also include the target fan and other fans, which is not limited in the present disclosure.

In the embodiments of the disclosure, the adjustment of the actual rotation speed of the to-be-adjusted fan may be to increase or reduce a predefined rotation speed for the actual rotation speed of the to-be-adjusted fan, or to perform weighted processing on the actual rotation speed of the to-be-adjusted fan based on a weight, which is not limited in the present disclosure.

In the embodiments of the disclosure, based on prior knowledge and/or actual conditions, a plurality of components are provided in the chassis of the electronic device, and the plurality of components include but are not limited to a central processing unit, a graphics processing unit, a hard disk, a memory, a sensor, and a power supply assembly.

In the embodiments of the disclosure, the characteristic parameters of each component include but are not limited to the temperature of each component, the storage read-write performance of the electronic device such as the read-write performance of a hard disk, and the rotation speed of all fans.

In the embodiments of the disclosure, the performance benchmark includes one or more of the following conditions: the temperature of each component meets the corresponding predefined temperature guideline; the storage read-write performance of the electronic device meets the read-write performance requirements; when the rotation speeds of the fans are adjusted, the sum of the rotation speeds of all the fans after the adjustment is identical to or close to the sum of the rotation speeds before the adjustment.

The predefined temperature guidelines may be understood as a series of safe operating temperature thresholds defined for each component in the server. The temperature thresholds are related to the performance specifications and temperature limits of the components, and are intended to ensure long-term stable operation while preventing performance degradation or hardware damage caused by overheating. It should be noted that due to the different performance specifications and temperature limits of the components, the temperature thresholds corresponding to different components may also be different.

The read-write performance benchmark refers to the read-write performance of the hard disk in the electronic device meeting the predefined read-write rate, which is related to the type of hard disk, performance specification parameters, and one or more of the interface and bus standards, and is intended to maximize the performance of the hard disk in the electronic device and meet the needs of efficient data processing. It should be noted that due to the different types of hard disks, performance specification parameters, and interface and bus standards, the predefined read-write rates corresponding to different hard disks are also different.

In the above case where the fan rotation speed is adjusted, the sum of the rotation speeds of all fans after adjustment is identical to or close to the sum of the rotation speeds before adjustment. It may be understood that, in the process of adjusting the fans, in order to maintain the overall air volume range of the electronic device to the minimum and/or the overall power consumption of the electronic device to the minimum, the overall rotation speed of the fans after adjustment may be set to be identical to or close to the overall rotation speed before adjustment of the fans, so as to avoid generating additional power consumption and wasting energy resources.

In the embodiments of the disclosure, the electronic device determines a target fan that causes the storage read-write performance of the electronic device to degrade based on the relationship between hard disks and fans in the electronic device, and then adjusts the actual rotation speed of the to-be-adjusted fan, so that the temperature of each component in the electronic device meets the corresponding predefined temperature guideline, and/or adjusts the actual rotation speed of the to-be-adjusted fan, so that the storage read-write performance of the electronic device meets the read-write performance benchmark. In this way, the target fan that causes the storage read-write performance to degrade is determined based on the relationship between hard disks and fans. Further, the rotation speed of the target fan is finely adjusted to avoid overcooling, meet the heat dissipation requirements, and/or reduce the physical vibration interference to the hard disk. This may effectively improve the hard disk read-write speed and data transmission efficiency, and ensure that the performance of the storage subsystem meets or exceeds the expected standards, which is crucial for applications that rely on high-speed data processing. In this way, the fine adjustment based on the relationship between hard disks and fans not only solves the problem of storage read-write performance degradation, but also improves the overall performance of the electronic device from multiple aspects, and achieves a more efficient, stable and environmentally friendly operating state.

Another embodiment of the disclosure provides a fan control method, which is applied to an electronic device. As shown in FIG. 2, the method includes the following steps.

Step 201: Determine a target hard disk with degraded read-write performance.

In the embodiments of the disclosure, the electronic device may monitor the read-write rate of each hard disk in itself in real time through an additional monitoring channel. When it is detected that the read-write rate of a hard disk is less than a predefined read-write rate, it is determined that the storage read-write performance of the hard disk has degraded, and the hard disk with the degraded storage read-write performance is determined as the target hard disk.

Step 202: Determine a target fan corresponding to the target hard disk based on one or more of a predefined relationship between the target hard disk and the fans, a position relationship between the target hard disk and the fans, and a relationship between fan rotation speed adjustments and changes in read-write performance of the target hard disk.

There are one or more target fans.

In the embodiments of the disclosure, the predefined relationship between the target hard disk and the fans may be a one-to-one predefined relationship between the target hard disk and the fans, or a one-to-many predefined relationship between the target hard disk and the fans.

In the embodiments of the disclosure, the positional relationship between the target hard disk and the fans may be determined based on the distance between the target hard disk and each fan.

In the embodiments of the disclosure, the relationship between the fan rotation speed adjustment and the read-write performance change of the target hard disk may be a relationship for determining whether the read-write performance of the target hard disk changes based on the fan rotation speed adjustment.

In some embodiments, determining the target fan corresponding to the target hard disk based on the predefined relationship between the target hard disk and the fans in step 202 may be achieved by the following step: determining a fan having a predefined corresponding relationship with the target hard disk as the target fan.

In the embodiments of the disclosure, a one-to-one correspondence or a one-to-many relationship between the target hard disk and the fans is predefined, thereby obtaining a first mapping relationship between the target hard disk and the fans. After the electronic device determines the target hard disk with degraded read-write performance, the fan corresponding to the target hard disk is searched in the first mapping relationship as the target fan. In this way, in the embodiments of the disclosure, when the read-write performance of the electronic device is degraded and the target hard disk with degraded read-write performance has been determined, by referring to the predefined first mapping relationship, the fan or fan group associated with the target hard disk may be quickly identified, which greatly improves the efficiency of fault diagnosis and reduces troubleshooting time. By analyzing the first mapping relationship, the fan configuration that may have a negative impact on the performance of the target hard disk may be identified in advance and adjusted, thereby preventing storage performance degradation and extending the service life of the hardware.

In some embodiments, in step 202, based on the positional relationship between the target hard disk and the fans, determining the target fan corresponding to the target hard disk may be achieved by the following step: obtaining the distance between the target hard disk and each fan; and determining the fan whose distance is less than the first distance as the target fan.

In the embodiments of the disclosure, the first distance is a distance threshold for selecting, from all fans, a fan closest to the target hard disk, and the first distance may also be a distance threshold for selecting multiple fans, from all fans, closest to the target hard disk, and fans within the distance threshold have a greater impact on the read-write performance of the hard disk. The present disclosure does not make specific restrictions on the number of fans.

In some embodiments, after determining the target hard disk with reduced read-write performance, the electronic device calculates the distance between the target hard disk and each fan among all fans, selects multiple fans, from all fans, whose distance is less than the first distance, and determines that the selected fans are the target fans corresponding to the target hard disk. Here, a second mapping relationship may exist between the target hard disk and the selected fans. Accordingly, firstly, the embodiments of the disclosure calculates the distance between the target hard disk and all fans, and set a threshold (i.e., first distance) to select fans whose distances meet the criteria. This approach may more accurately identify the fans that have the greatest impact on the heat dissipation and vibration of the target hard disk, thereby avoiding blindly adjusting all fans, being more targeted, and improving the accuracy of problem solving. Secondly, since the selected fans are directly related to the microenvironment of the target hard disk, the refined adjustment of their rotation speeds may more effectively control the temperature around the hard disk and reduce unnecessary vibration, thereby improving the working conditions of the hard disk and improving the read-write performance. Further, after establishing a second mapping relationship between the target hard disk and the selected fans, the future maintenance and troubleshooting process will be more simplified. Maintenance personnel may directly refer to the mapping relationship to quickly locate and handle problems and improve work efficiency.

In some embodiments, after the electronic device determines the target hard disk with degraded read-write performance, if there is a one-to-many first mapping relationship between the target hard disk and the fans, the electronic device calculates the distance between the target hard disk and each fan identified through the first mapping relationship, selects one or more fans with a distance less than the first distance from the fans with the first mapping relationship, and determines that the selected fans are the target fans corresponding to the target hard disk. Here, a third mapping relationship may exist between the target hard disk and the selected fans. Accordingly, firstly, by calculating the distance between the target hard disk and all fans with the first mapping relationship, the embodiments of the disclosure reduce the range of fans whose distances need to be calculated, reduce the amount of calculation, and thus improve the efficiency of finding fans that affect the performance degradation of the target hard disk. The computing resources are reduced and the computing efficiency is improved. Next, based on the predefined first distance threshold, the fans with the most direct impact are selected, and the key fans that have a negative impact on the performance of the target hard disk may be accurately identified. Further, after identifying the fans with a distance less than the set threshold (i.e., first distance) from the target hard disk and having a direct impact, a third mapping relationship is formed. This facilitates the targeted optimization of the operating parameters (e.g., rotation speed, working mode, etc.) of these fans, while ensuring the heat dissipation efficiency, reducing the interference with the hard disk read-write performance, and realizing the refined management of resources.

In some embodiments, determining the target fan corresponding to the target hard disk based on the relationship between the fan rotation speed adjustment and the read-write performance change of the target hard disk in step 202 may be achieved through the following step: adjusting the actual rotation speed of each fan in turn, and obtaining a monitoring result of whether the read-write performance of the target hard disk has changed; and when the monitoring result indicates that the read-write performance of the target hard disk has changed, determining that the currently adjusted fan is the target fan.

In some embodiments, after the electronic device determines the target hard disk with degraded read-write performance, the electronic device adjusts the actual rotation speeds of all fans in the electronic device in turn. After adjusting the rotation speed of each fan, the electronic device observes whether the read-write performance of the target hard disk changes. If the read-write performance of the target hard disk changes, the electronic device determines that the currently adjusted fan causes the read-write performance of the target hard disk to degrade, and determines the currently adjusted fan as the target fan. In this way, by adjusting the fan rotation speeds one by one and observing the results, the embodiments of the disclosure may directly observe which fan's rotation speed change directly affects the read-write performance of the target hard disk. This approach may intuitively and accurately identify the root cause of the problem, avoiding unnecessary assumptions and speculations. Furthermore, the fine-tuning of the fan rotation speeds one by one reflects a highly refined management strategy, which is conducive to discovering and optimizing factors that have subtle effects on system performance, and improving the overall efficiency and stability of the system.

In some embodiments, after determining the target hard disk with degraded read-write performance, the electronic device first obtains a one-to-many target mapping relationship between the target hard disk and the fans, where the target mapping relationship includes one or more of a first mapping relationship, a second mapping relationship, and a third mapping relationship. Secondly, the actual rotation speeds of the fans in the electronic device that have a target mapping relationship with the target hard disk are adjusted in turn. After adjusting the rotation speed of each fan, observe whether the read-write performance of the target hard disk changes. If the read-write performance of the target hard disk changes, it is determined that the currently adjusted fan causes the read-write performance of the target hard disk to degrade, and the currently adjusted fan is determined as the target fan. Thus, firstly, the embodiments of the disclosure only specifically adjusts the actual rotation speeds of the fans, that have a target mapping relationship with the target hard disk, one by one, thereby greatly reducing the number of fans that need to adjust the rotation speed, thereby significantly improving the efficiency of the troubleshooting and optimization process and saving valuable time and resources. Secondly, by adjusting the fan rotation speeds one by one and observing the results, it is possible to directly see which fan rotation speed change directly affects the read-write performance of the target hard disk. This approach may intuitively and accurately identify the root cause of the problem and avoid unnecessary assumptions and speculations. Further, the fine-tuning of fan rotation speeds one by one reflects a highly refined management strategy, which helps to discover and optimize factors that have subtle effects on system performance, thereby improving the overall efficiency and stability of the system.

Step 203: Adjust the actual rotation speed of the to-be-adjusted fan so that the characteristic parameters of each component in the electronic device meet the performance benchmark.

The to-be-adjusted fan is determined based on the target fan.

Here, the characteristic parameters of each component meeting the performance benchmark includes: the temperature of each component meeting the corresponding predefined temperature guideline, and/or the storage read-write performance of the electronic device meeting the read-write performance benchmark, and each component including a hard disk.

In some embodiments, the to-be-adjusted fan includes a target fan, and the actual rotation speed of the to-be-adjusted fan in step 203 may be adjusted through the following process.

The actual rotation speed of the target fan is gradually reduced or increased with a first step rotation speed, or, obtain a first weight of the target fan; based on the first weight, gradually reduce or increase the actual rotation speed of the target fan. Here, the weight is determined based on the distance between each fan and the target hard disk, and/or the degree of influence of each fan on the target hard disk, and the target hard disk is a hard disk with degraded storage read-write performance in the electronic device.

In the embodiments of the disclosure, the first step rotation speed may be a predefined fixed rotation speed value, or may be determined based on a first percentage value of the maximum rotation speed of the target fan, such as 10%. Apparently, the first step rotation speed may also be determined based on a second percentage value of the current rotation speed of the target fan, where the first percentage value is different from or the same as the second percentage value. The present disclosure does not impose any specific restrictions on the setting of the first step rotation speed.

In the embodiments of the disclosure, the first weight may be determined based on the distance between the target fan and the target hard disk. For example, the closer the distance between the target fan and the target hard disk is, the greater the weight is. On the contrary, the farther the distance between the target fan and the target hard disk is, the smaller the weight is. Apparently, the first weight may also be determined by the degree of influence of the target fan on the read-write performance of the target hard disk. For example, the greater the degree of influence of the target fan on the read-write performance of the target hard disk is, the greater the weight is. On the contrary, the smaller the degree of influence of the target fan on the read-write performance of the target hard disk is, the smaller the weight is.

In some embodiments, after determining the target fan corresponding to the target hard disk, the actual rotation speed of the target fan is gradually reduced or increased with a first step rotation speed. It should be noted that the embodiments of the disclosure reduce or increase the actual rotation speed of the target fan with a first step rotation speed. In this way, by adjusting the fan rotation speed in smaller steps, it is possible to achieve refined control of the heat dissipation effect, which helps to more accurately match the current heat dissipation requirements, avoid temperature fluctuations caused by excessive rotation speed adjustment, and maintain stable system operation. Meanwhile, compared with directly adjusting the fan rotation speed significantly, a gradual adjustment may more smoothly achieve the required heat dissipation level and reduce unnecessary energy consumption. Meanwhile, small step rotation speed adjustment may reduce the noise generated by high-speed operation of the fan.

Next, after each time the actual rotation speed of the target fan is reduced or increased at the first step rotation speed, the electronic device may detect the temperature of each component in the electronic device and/or the read-write rate of the target hard disk (e.g., through the BMC). In this way, the electronic device of the embodiments of the disclosure continuously monitors the temperature of each component and/or the read-write performance of the hard disk, and may capture any temperature change of each component in the electronic device and/or fluctuations in the read-write performance of the hard disk at the first time.

Furthermore, the electronic device determines whether the temperature of each component meets the corresponding predefined temperature guideline, and/or whether the read-write rate of the target hard disk meets the read-write performance benchmark. If it is determined that the temperature of each component does not meet the corresponding predefined temperature guideline, and/or the read-write rate of the target hard disk does not meet the read-write performance benchmark, the actual rotation speed of the target fan is reduced or increased at the first step rotation speed. Accordingly, the electronic device timely adjusts the fan rotation speed to cope with the above conditions. This instant feedback mechanism ensures a quick response to heat dissipation needs and achieves more refined temperature control.

Apparently, if the electronic device determines that the temperature of each component meets the corresponding predefined temperature guideline, and/or the read-write rate of the target hard disk meets the read-write performance benchmark, stop reducing or increasing the actual rotation speed of the target fan at the first incremental rotation speed. In this way, the adjustment is stopped after the ideal heat dissipation effect is achieved, thereby avoiding energy waste caused by excessive heat dissipation, helping to reduce the system failure rate, and ensuring stable and continuous operation of electronic device, which is especially important for data processing and storage intensive applications. Meanwhile, timely stopping unnecessary fan speed adjustments may reduce power consumption, reduce operating costs, and reduce wear on motors and other mechanical components in electronic device, thereby extending service life.

In some embodiments, after determining the target fan corresponding to the target hard disk, the first weight of the target fan relative to the target hard disk is obtained, and the actual rotation speed of the target fan is gradually reduced or increased based on the first weight. It should be noted that the embodiments of the disclosure reduce or increase the actual rotation speed of the target fan based on the first weight. In this way, the embodiments of the disclosure dynamically adjust the actual rotation speed of the target fan according to the distance between the target fan and the target hard disk and the degree of influence, and may more accurately guide cold air to key areas that require heat dissipation, especially around hard disks with heavy workloads or high temperatures. This may not only effectively dissipate heat, but also avoid overcooling other components, thereby saving energy.

Next, each time after lowering or increasing the actual rotation speed of the target fan based on the first weight, the electronic device may detect the temperature of each component in the electronic device and/or the read-write rate of the target hard disk (e.g., through the BMC). In this way, the electronic device of the embodiments of the disclosure continuously monitors the temperature of each component and/or the read-write performance of the hard disk, and may capture any temperature change of each component in the electronic device and/or fluctuations in the read-write performance of the hard disk at the first time.

Furthermore, the electronic device determines whether the temperature of each component meets the corresponding predefined temperature guideline, and/or whether the read-write rate of the target hard disk meets the read-write performance benchmark. If it is determined that the temperature of each component does not meet the corresponding predefined temperature guideline, and/or the read-write rate of the target hard disk does not meet the read-write performance benchmark, the actual rotation speed of the target fan is further reduced or increased based on the first weight. In this way, the electronic device adjusts the fan rotation speed in time to cope with the above conditions. This instant feedback mechanism ensures a rapid response to heat dissipation needs and achieves more refined temperature control.

Apparently, if the electronic device determines that the temperature of each component meets the corresponding predefined temperature guideline, and/or the read-write rate of the target hard disk meets the read-write performance benchmark, stop reducing or increasing the actual rotation speed of the target fan based on the first weight. In this way, excessive cooling or overheating may be avoided, and the hardware may be maintained within the most suitable operating temperature range. This helps to reduce the system failure rate and ensure the stable and continuous operation of the electronic device, which is especially important for data processing and storage intensive applications. Meanwhile, timely stopping unnecessary fan speed adjustments may reduce power consumption and operating costs, while reducing the wear of motors and other mechanical components in electronic device and extending service life.

In some embodiments, the to-be-adjusted fan also extends to include the remaining fans among all the fans except the target fan. Adjusting the actual rotation speed of the to-be-adjusted fan in step 203 may be achieved through the following process.

Gradually reduce or increase the actual rotation speed of the target fan with a first step rotation speed, and gradually reduce or increase the actual rotation speed of the actual rotation speed of the remaining fans with a second step rotation speed, where the first step rotation speed is the same as or different from the second step rotation speed. Alternatively, obtain a first weight of the target fan and a second weight of remaining fans, and gradually reduce or increase the actual rotation speed of the target fan based on the first weight, and gradually increase or reduce the actual rotation speed of remaining fans based on the second weight. Here, the weights are determined based on the distance between each fan and the target hard disk, and/or the degree of influence of each fan on the target hard disk. The target hard disk is a hard disk with degraded storage read-write performance in an electronic device.

In the embodiments of the disclosure, the first step rotation speed may be a predefined fixed rotation speed value, or the first step rotation speed may be determined based on a first percentage value of the maximum rotation speed of the target fan, such as 10%. Apparently, the first step rotation speed may also be determined based on a second percentage value of the current rotation speed of the target fan, where the first percentage value is different from the second percentage value. The present disclosure does not impose any specific restrictions on the setting of the first step rotation speed.

In the embodiments of the disclosure, the remaining fans may be other fans among all fans except the target fan, and the remaining fans may also be other fans except the target fan among fans that have a one-to-many target mapping relationship with the target hard disk. The target mapping relationship includes one or more of the first mapping relationship, the second mapping relationship and the third mapping relationship described above.

In the embodiments of the disclosure, the second step rotation speed may be a predefined fixed rotation speed value, or the second step rotation speed may be determined based on a third percentage value of the maximum rotation speed of each of the remaining fans, and/or the distance between each fan and the target hard disk. Apparently, the second step rotation speed may also be determined based on a fourth percentage value of the current rotation speed corresponding to each of the remaining fans, where the third percentage value is different from or the same as the fourth percentage value. The second step rotation speed may be less than the first step rotation speed. The present disclosure does not impose any specific restrictions on the setting of the second step rotation speed.

In the embodiments of the disclosure, the first weight may be determined based on the distance between the target fan and the target hard disk. For example, the closer the distance between the target fan and the target hard disk is, the greater the weight is. On the contrary, the farther the distance between the target fan and the target hard disk is, the smaller the weight is. Apparently, the first weight may also be determined by the degree of influence of the target fan on the read-write performance of the target hard disk. For example, the greater the degree of influence of the target fan on the read-write performance of the target hard disk is, the greater the weight is. On the contrary, the smaller the degree of influence of the target fan on the read-write performance of the target hard disk is, the smaller the weight is.

In the embodiments of the disclosure, the second weight may be determined based on the distance between each of the remaining fans and the target hard disk. For example, the closer the distance between each of the remaining fans and the target hard disk is, the greater the weight is. On the contrary, the farther the distance between each of the remaining fans and the target hard disk is, the smaller the weight is. Apparently, the second weight may also be determined by the degree of influence of each of the remaining fans on the read-write performance of the target hard disk. For example, the greater the degree of influence of each of the remaining fans on the read-write performance of the target hard disk is, the greater the weight is. On the contrary, the smaller the degree of influence of each of the remaining fans on the read-write performance of the target hard disk is, the smaller the weight is. It should be noted that the second weight may be much smaller than the first weight.

In some embodiments, after determining the target fan corresponding to the target hard disk, the actual rotation speed of the target fan is gradually reduced or increased with a first step rotation speed, and the actual rotation speed of the remaining fans is gradually increased or reduced with a second step rotation speed different from the first step rotation speed. It should be noted that the embodiments of the disclosure reduce or increase the actual rotation speed of the target fan with a first step rotation speed, and increases or reduces the actual rotation speed of the remaining fans with a second step rotation speed different from the first step rotation speed. In this way, according to the location of different fans and the degree of direct impact on the target hard disk, the rotation speed is adjusted by different step rotation speeds, which may more accurately match the actual heat dissipation requirements of each area and realize differentiated heat dissipation management. In this way, it may effectively strengthen the heat dissipation for hot spots and avoid unnecessary airflow interference or energy consumption increase for the entire system. Meanwhile, a more refined first step rotation speed adjustment is adopted for the target fan that directly affects the heat dissipation of the target hard disk, which may achieve the ideal heat dissipation effect faster and reduce energy consumption. Meanwhile, adopting different second step rotation speeds for other fans may further optimize energy consumption and improve system energy efficiency under the premise of ensuring the overall heat dissipation requirements. By adjusting the fan rotation speed in smaller steps, the cooling effect may be finely controlled, which helps to more accurately match the current cooling needs, avoid temperature fluctuations caused by excessive rotation speed adjustment, and maintain stable system operation. Meanwhile, compared with directly adjusting the fan rotation speed by a large amount, a gradual adjustment may more smoothly achieve the required cooling level and reduce unnecessary energy consumption. Meanwhile, small-step rotation speed adjustment may reduce the noise generated by high-speed fan operation.

Next, after each time the actual rotation speed of the target fan is reduced or increased at the first step rotation speed, and the actual rotation speed of the remaining fans is increased or reduced at the second step rotation speed different from the first step rotation speed. The electronic device may (e.g., through the BMC) detect the temperature of each component in the electronic device and/or the read-write rate of the target hard disk. In this way, the electronic device of the embodiments of the disclosure continuously monitors the temperature of each component and/or the read-write performance of the hard disk, and may capture any temperature change of each component in the electronic device and/or fluctuations in the read-write performance of the hard disk at the first time.

Furthermore, the electronic device determines whether the temperature of each component meets the corresponding predefined temperature guideline, and/or whether the read-write rate of the target hard disk meets the read-write performance benchmark. If it is determined that the temperature of each component does not meet the corresponding predefined temperature guideline, and/or the read-write rate of the target hard disk does not meet the read-write performance benchmark, the actual rotation speed of the target fan is continuously reduced or increased at the first step rotation speed, and the actual rotation speed of the remaining fans is increased or reduced at the second step rotation speed different from the first step rotation speed. In this way, the electronic device timely adjusts the fan rotation speed to respond based on the above conditions. This instant feedback mechanism ensures a rapid response to heat dissipation needs and achieves more refined temperature control.

Apparently, if the electronic device determines that the temperature of each component meets the corresponding predefined temperature guideline, and/or the read-write rate of the target hard disk meets the read-write performance benchmark, stop reducing or increasing the actual rotation speed of the target fan at the first step rotation speed, and stop gradually increasing or reducing the actual rotation speed of the remaining fans at a second step rotation speed different from the first step rotation speed. In this way, the adjustment is stopped after the ideal heat dissipation effect is achieved, thereby avoiding energy waste caused by excessive heat dissipation, helping to reduce the system failure rate, and ensuring stable and continuous operation of electronic device, which is especially important for data processing and storage intensive applications. Meanwhile, timely stopping unnecessary fan speed adjustments may reduce power consumption, reduce operating costs, and reduce wear on motors and other mechanical components in electronic device, thereby extending service life.

In some embodiments, after determining the target fan corresponding to the target hard disk, the first weight of the target fan relative to the target hard disk is obtained, and the actual rotation speed of the target fan is successively reduced or increased based on the first weight. It should be noted that the embodiments of the disclosure reduce or increase the actual rotation speed of the target fan based on the first weight, and increases or reduces the actual rotation speed of the remaining fans based on the second weight. In this way, the embodiments of the disclosure give a higher weight (first weight) to the target fan that directly affects the heat dissipation of the target hard disk, and preferentially adjusts its rotation speed, which may achieve the ideal heat dissipation effect faster and reduce energy consumption. The adjustment of other fans with a smaller weight (second weight) is more conservative, ensuring the maximization of overall energy efficiency. According to the location of different target fans and the degree of direct influence on the target hard disk, as well as the degree of direct influence of the location of the remaining fans on the target hard disk, different weights are used to adjust the actual rotation speeds of the target fans and the remaining fans in two different directions (increase or reduce), respectively, which may more accurately match the actual heat dissipation requirements of each area and realize differentiated heat dissipation management. In this way, it may effectively strengthen heat dissipation for hot spots and avoid unnecessary airflow interference or energy consumption increase for the entire system. Meanwhile, a more refined first-step rotation speed adjustment is used for the target fan that directly affects the heat dissipation of the target hard disk, which may achieve the ideal heat dissipation effect faster and reduce energy consumption. Meanwhile, different second-step rotation speeds are used for other fans, which may further optimize energy consumption and improve system energy efficiency while ensuring the overall heat dissipation requirements. Based on a smaller weight, adjusting the fan rotation speed may achieve refined control of the heat dissipation effect, which helps to more accurately match the current heat dissipation requirements, avoid temperature fluctuations caused by excessive rotation speed adjustment, and maintain stable system operation. Meanwhile, compared with directly adjusting the fan rotation speed significantly, a gradual adjustment may more smoothly achieve the required heat dissipation level and reduce unnecessary energy consumption. Meanwhile, rotation speed adjustment with a smaller weight may reduce the noise generated by high-speed operation of the fan.

Next, each time the actual rotation speed of the target fan is reduced or increased based on the first weight, and the actual rotation speed of the remaining fans is increased or reduced based on the second weight, the electronic device may detect the temperature of each component in the electronic device and/or the read-write rate of the target hard disk (e.g., through the BMC). In this way, the electronic device of the embodiments of the disclosure continuously monitors the temperature of each component and/or the read-write performance of the hard disk, and may capture any temperature change of each component in the electronic device and/or fluctuations in the read-write performance of the hard disk at the first time.

Furthermore, the electronic device determines whether the temperature of each component meets the corresponding predefined temperature guideline, and/or whether the read-write rate of the target hard disk meets the read-write performance benchmark. If it is determined that the temperature of each component does not meet the corresponding predefined temperature guideline, and/or the read-write rate of the target hard disk does not meet the read-write performance benchmark, the actual rotation speed of the target fan is continuously reduced or increased based on the first weight, and the actual rotation speed of the remaining fans is gradually increased or reduced based on the second weight. In this way, the electronic device timely adjusts the fan rotation speed to respond based on the above conditions. This instant feedback mechanism ensures a rapid response to heat dissipation needs and achieves more refined temperature control.

Apparently, if the electronic device determines that the temperature of each component meets the corresponding predefined temperature guideline, and/or the read-write rate of the target hard disk meets the read-write performance benchmark, stop reducing or increasing the actual rotation speed of the target fan based on the first weight, and stop gradually increasing or reducing the actual rotation speed of the remaining fans based on the second weight. In this way, excessive cooling or overheating may be avoided, and the hardware may be maintained within the most suitable operating temperature range. This helps to reduce the system failure rate and ensure the stable and continuous operation of electronic device, which is especially important for data processing and storage intensive applications. Meanwhile, timely stopping unnecessary fan speed adjustments may reduce power consumption and operating costs, while reducing the wear of motors and other mechanical components in electronic device and extending their service life.

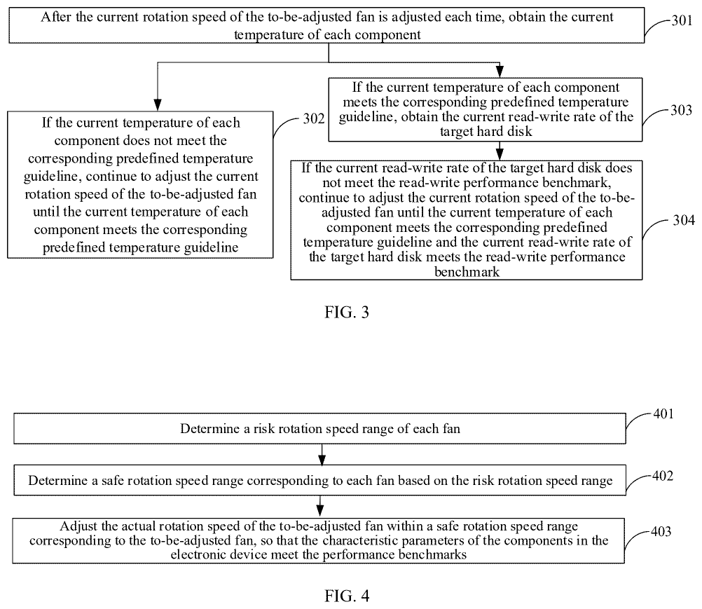

In some embodiments, the actual rotation speed of the to-be-adjusted fan may be adjusted once or multiple times. After each adjustment of the actual rotation speed of the to-be-adjusted fan, the steps shown in FIG. 3 may be performed.

Step 301: After the current rotation speed of the to-be-adjusted fan is adjusted each time, obtain the current temperature of each component.

The current rotation speed includes: the adjusted actual rotation speed and/or the actual rotation speed.

In the embodiments of the disclosure, each component may refer to all components in the electronic device, and each component may also refer to a key component in the electronic device, which is not limited in the present disclosure.

In the embodiments of the disclosure, the current temperature is the temperature of the component at the current moment after the current rotation speed of the to-be-adjusted fan is adjusted.

In the embodiments of the disclosure, since the electronic device may gradually adjust the rotation speed of the to-be-adjusted fan based on a step rotation speed or a weight, each time the electronic device adjusts the current rotation speed of the to-be-adjusted fan, the electronic device may detect the temperature of each component in the electronic device through the BMC. In this way, after the electronic device adjusts the rotation speed of the fan, the electronic device may capture any temperature changes of the components in the electronic device for the first time, so as to determine whether the components in the electronic device meet the corresponding predefined temperature guideline. Further, by finely adjusting the fan rotation speed, the temperature of each component inside the electronic device may be maintained within an ideal range, thereby avoiding local overheating and extending the service life of the hardware.

Step 302: If the current temperature of each component does not meet the corresponding predefined temperature guideline, continue to adjust the current rotation speed of the to-be-adjusted fan until the current temperature of each component meets the corresponding predefined temperature guideline.

In the embodiments of the disclosure, for the actual rotation speed of the to-be-adjusted fan and after each adjustment of the actual rotation speed, the current temperature of each component is obtained. If each current temperature does not meet the corresponding predefined temperature guideline, the current rotation speed of the to-be-adjusted fan is adjusted continuously until the current temperature of each component meets the corresponding predefined temperature guideline. In this way, since the stability of temperature is directly related to the stability of the performance of the electronic device, the temperature may be controlled by adjusting the fan rotation speed in real time in a multi-stage refined manner, which may ameliorate the performance degradation or system instability caused by overheating, ensure continuous high-performance output, ensure stable and efficient operation of the system, and improve the reliability of the system and the stability of long-term operation.

Step 303: If the current temperature of each component meets the corresponding predefined temperature guideline, obtain the current read-write rate of the target hard disk.

The target hard disk is a hard disk in an electronic device with degraded storage read-write performance.

In the embodiments of the disclosure, in order to ensure the stability and reliability of the electronic device, first ensure that the operating temperature of each component is maintained within a safe range, that is, monitor the current temperature of the components in the electronic device in real time to ensure that these components do not exceed the temperature threshold set for each component. The temperature threshold is intended to prevent performance degradation or hardware damage caused by overheating, and is the basis for ensuring the normal operation of the device. Complying with the temperature threshold is the first line of defense to prevent overheating damage. Before any performance optimization is performed, first ensure that the temperature of all components meets the safety standards. Only when the temperature of all components is under control, that is, it does not exceed the respective temperature threshold, may other performance adjustments be further considered. Further, on the basis of completing the temperature management, the read-write performance of the hard disk is further considered, especially the monitoring of the read-write rate of the hard disk. Therefore, the current read-write rate of the target hard disk is obtained, which is used as the basis for evaluating whether the fan rotation speed continues to be adjusted. Here, based on the actual read-write rate of the target hard disk, it is analyzed whether it is necessary to further adjust the fan rotation speed related to the read-write rate. If the read-write rate fails to meet expectations or there is a downward trend, consider optimizing the heat dissipation conditions by adjusting the fan rotation speed to indirectly improve the hard disk performance.

Step 304: If the current read-write rate of the target hard disk does not meet the read-write performance benchmark, continue to adjust the current rotation speed of the to-be-adjusted fan until the current temperature of each component meets the corresponding predefined temperature guideline and the current read-write rate of the target hard disk meets the read-write performance benchmark.

Here, read-write performance includes the read-write rate.

In the embodiments of the disclosure, the current read-write rate meeting the read-write performance benchmark includes: the current read-write rate being greater than or equal to a predefined read-write rate, where the predefined read-write rate is used to ensure that the hard disk performance in the electronic device is maximized to meet the needs of efficient data processing.

In the embodiments of the disclosure, when the current read-write rate of the target hard disk does not meet the read-write performance benchmark, the current rotation speed of the to-be-adjusted fan is adjusted once or multiple times. After each adjustment of the actual rotation speed of the to-be-adjusted fan, the current temperature of each component is obtained. If each current temperature meets the corresponding predefined temperature guideline, the current read-write rate of the target hard disk is obtained until the current temperature of each component meets the corresponding predefined temperature guideline, and the current read-write rate of the target hard disk meets the read-write performance benchmark. As can be seen from the above, when the read-write rate of the target hard disk does not meet the performance benchmark, the fan rotation speed is adjusted carefully, and the temperature of the components and the read-write rate of the target hard disk are monitored after each adjustment until both the temperature threshold and the performance benchmark are met. In this way, by continuously monitoring and ensuring that the temperature of all components is maintained within the predefined safety range, hardware damage and system failure caused by overheating are effectively prevented, and the overall stability and operation safety of the electronic device are improved. And the fan rotation speed is adjusted in a targeted manner, the heat dissipation conditions of the target hard disk are improved and unnecessary vibration interference is reduced. This directly promotes the improvement of the hard disk read-write rate until the expected performance benchmark is reached, and the data processing efficiency and the response speed of the storage subsystem are ensured. Further, while ensuring that the temperature and performance meet the standards, unnecessary high-speed operation of the fan is avoided, energy consumption is reduced, which is conducive to energy conservation, emission reduction and lower operating costs.

In summary, since temperature stability is directly related to the stability of electronic device performance, controlling temperature by fine-tuning fan rotation speed in real time in multiple stages may ameliorate performance degradation or system instability caused by overheating, ensure continuous high-performance output, ensure stable and efficient system operation, and improve system reliability and long-term operation stability.

In some embodiments, before performing step 203 to adjust the actual rotation speed of the to-be-adjusted fan, the steps shown in FIG. 4 may also be performed.

Step 401: Determine a risk rotation speed range of each fan.

Wherein, each fan includes a target fan.

In the embodiments of the disclosure, the risk rotation speed range may be determined based on the following two methods.

Method 1: Determine the risk rotation speed range based on the obtained vibration frequency of the fan and the sensitive frequency of the hard disk.

Here, there are different ways to obtain the vibration frequency of the fan. For example, vibration frequency of the fan may be obtained by the current rotation speed of the fan. If the current vibration frequency of the fan is obtained by the current rotation speed of the fan, then it is naturally necessary to first obtain the current rotation speed of the fan. To obtain the current rotation speed of the fan, there are also different ways to obtain it, such as monitoring the rotation speed of the fan in real time through the BMC. The embodiments of the disclosure do not make specific restrictions on the way of obtaining the rotation speed of the fan.

Here, the sensitive frequency of the hard disk may include a frequency that may cause the hard disk to resonate. The sensitive frequency of a hard disk may include at least one of a frequency point and a frequency band. For example, the sensitive frequency of a hard disk may include at least one frequency point and/or at least one frequency band. Optionally, the sensitive frequency of the hard disk may be provided by the manufacturer when the hard disk is produced, for example, the sensitive frequency may be obtained through the manual of the hard disk provided by the manufacturer, or may be obtained by testing and measuring the hard disk, which is not limited in the present disclosure.

In actual applications, when the vibration frequency of the fan is close to or equal to the sensitive frequency of the hard disk, it may cause the hard disk read-write head to jump or the internal structure to resonate, affecting the data reading and writing performance, or even causing physical damage. Therefore, the embodiments of the disclosure obtain the current vibration frequency of each fan and the sensitive frequency of each hard disk, compare the vibration frequency of each fan with the sensitive frequency of each hard disk, and find the matching results of the overlapping area between the two. Further, based on the above matching results, the specific rotation speed range of each fan relative to each hard disk is determined. It should be noted that within this specific rotation speed range, its vibration frequency matches the sensitive frequency of the hard disk(s), constituting a risk rotation speed range.

Method 2: When there is a target hard disk with reduced read-write performance in the electronic device, for the target fan corresponding to the target hard disk, the rotation speed value of the target fan is gradually reduced until the read-write rate of the target hard disk returns to normal, and the rotation speed value upper limit of the target fan is recorded. Further, the rotation speed value of the target fan is gradually increased until the read-write rate of the target hard disk returns to normal, and the rotation speed value lower limit of the target fan is recorded. The interval formed by the upper limit rotation speed value and the lower limit rotation speed value is determined as the fan rotation speed range.

Step 402: Determine a safe rotation speed range corresponding to each fan based on the risk rotation speed range.

In the embodiments of the disclosure, within a predefined interval, the risk rotation speed range is eliminated to obtain the safe rotation speed range corresponding to the fan.

Further, adjusting the actual rotation speed of the to-be-adjusted fan in step 203 includes the following step 403.

Step 403: Adjust the actual rotation speed of the to-be-adjusted fan within the safe rotation speed range corresponding to the to-be-adjusted fan, so that the characteristic parameters of the components in the electronic device meet the performance benchmarks.

In the embodiments of the disclosure, after the electronic device determines the safe rotation speed range corresponding to each fan, the actual rotation speed of the to-be-adjusted fan is adjusted within the safe rotation speed range corresponding to the to-be-adjusted fan, so that the characteristic parameters of the components in the electronic device meet the performance benchmarks. In this way, within the determined safe rotation speed range, a method of gradually adjusting the fan rotation speed by a small amplitude is adopted. After each adjustment, the system status, especially the read-write rate of the target hard disk and the temperature of the components in the system, must be monitored. Further, the hard disk read-write rate is monitored in real time. If the read-write rate begins to rise or stabilizes at a satisfactory level, it means that the current fan rotation speed is appropriate. If the read-write rate decreases, it may be necessary to go back to the previous rotation speed or try a lower rotation speed. In this way, through careful adjustment, the read-write performance of the hard disk is effectively improved or restored to ensure data processing efficiency. Meanwhile, ensure that the temperature of the components is maintained within a safe range during all adjustments to avoid overheating. Vibration sensor monitoring is used to avoid system resonance caused by fan rotation speed adjustment. Hard disk performance attenuation caused by physical interference such as resonance is avoided, and system stability is enhanced.

Next, an exemplary application scenario is further described. The continuous increase in power consumption of electronic device such as server systems has led to a sharp increase in heat dissipation pressure. The fan rotation speed has increased rapidly, bringing stronger air volume while also generating higher vibration and noise. The impact of system fan noise is a key factor in causing the hard disk read-write performance loss validation (PLV). In response to the PLV problem, related technologies directly limit the maximum fan rotation speed value to ensure that the PLV risk is reduced, resulting in performance waste and reducing the system's maximum heat dissipation capacity.

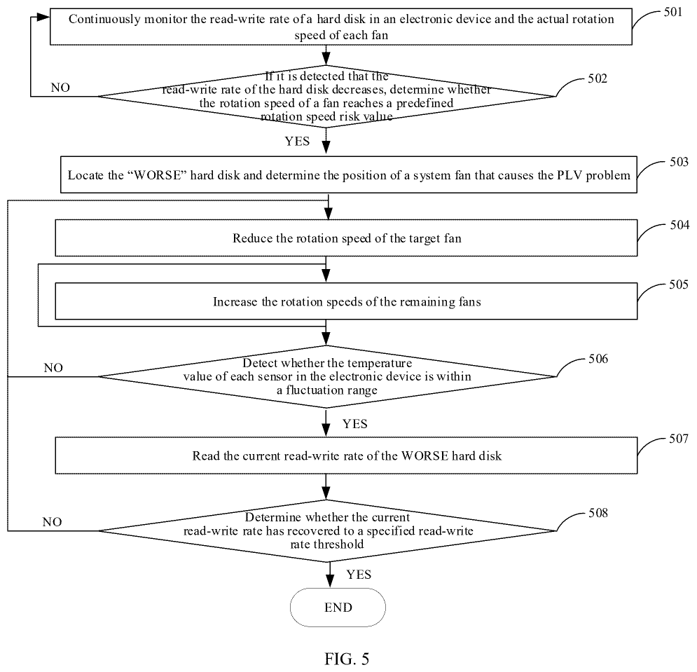

In order to solve the above problems, embodiments of the disclosure provide a fan control method. Referring to FIG. 5, the method includes the following steps.

Step 501: Continuously monitor the read-write rate of a hard disk in an electronic device and the actual rotation speed of each fan.

Here, the electronic device may monitor the read-write rate of each hard disk by adding a channel monitoring of the hard disk read-write rates through channels such as BMC or web, thereby realizing the monitoring of the read-write rate of each hard disk.

In some embodiments, while detecting the actual rotation speed of the fan, the fan rotation speed that causes the PLV problem may also be collected through the fan's operating data, and the risk rotation speed range may be accurately determined. When adjusting the fan rotation speed, the risk rotation speed range may be automatically avoided to avoid risks. For example, if the running fans include fans 0, 1, 2, and 3, if fan 0 causes the PLV problem of the hard disk, for fan 0, the rotation speed is gradually reduced from the real-time rotation speed value by X revolutions per minute (RPM), until the hard disk read-write rate returns to normal, and the rotation speed value upper limit is recorded. Similarly, the rotation speed value lower limit is obtained. Such risk rotation speed range is avoided from the rotation speed control strategy. For the remaining fans, the system increases the fan rotation speed, and similarly obtains the risk rotation speed range for avoidance. After the PLV problem disappears, fans 0-3 take rotation speed values within the safe rotation speed range. If fans 0 and 1 cause PLV problems at the same time, the two fans are solved in the same way.

Step 502: If it is detected that the read-write rate of the hard disk decreases, determine whether the rotation speed of a fan reaches a predefined rotation speed risk value.

In the embodiments of the disclosure, when the electronic device detects that the hard disk read-write rate has dropped, the real-time rotation speed of the fan in the running state in the electronic device is read, and it is determined whether the real-time rotation speed exceeds the predefined rotation speed risk value, so as to determine whether the PLV problem is caused by the fan rotation speed being too high.

Here, the embodiments of the disclosure determine whether the rotation speed of the fan in the electronic device reaches a predefined rotation speed risk value. If so, step 503 is executed; if not, the process returns to step 501 to continue monitoring.

Step 503: Locate the “WORSE” hard disk and determine the position of the system fan that causes the PLV problem.

Here, if the read-write rate of the hard disk is lower than the predefined read-write rate corresponding to the hard disk, the hard disk is determined to be a WORSE hard disk (which may correspond to the target hard disk). Further, based on the relationship between hard disks and fans, the target fan causing the PLV problem of the WORSE hard disk is determined.

Step 504: Reduce the rotation speed of the target fan.

Here, if the rotation speed of the target fan is A1 RPM, the electronic device may reduce the rotation speed of the target fan by the first step rotation speed T1 or the first weight W1 to obtain a rotation speed A2 of the target fan after one reduction.

It should be noted that after executing step 504, either step 505 or step 506 may be continuously implemented, which is not limited in the present disclosure.

Step 505: Increase the rotation speeds of the remaining fans.

Here, the remaining fans include all fans in operation except the target fan.

Here, if the rotation speed of each of the remaining fans is B1 RPM, the electronic device may increase the rotation speed of each of the remaining fans by the second step rotation speed T2 or the second weight W2 to obtain an increased rotation speed B2 of each of the remaining fans.

It should be noted that the rotation speed of each of the remaining fans is different, and the closer the distance between each of the remaining fans and the WORSE disk is, the lesser the second step rotation speed T2 or the second weight W2 is, and the second step rotation speed T2 is less than the first step rotation speed T1, and the second weight W2 is less than the first weight W1.

Step 506: Detect whether the temperature value of each sensor in the electronic device is within a fluctuation range.

Here, the electronic device monitors the value of the temperature change of the sensor inside itself caused by the change of the fan rotation speed, and determines whether the sensor temperature after the rotation speed change is within the fluctuation range corresponding to the sensor (e.g., corresponding to the predefined temperature guideline). If the sensor temperature exceeds the fluctuation range, the method returns to step 504 to continue execution. If the sensor temperature does not exceed the fluctuation range, the method proceeds to step 507.

Step 507: Read the current read-write rate of the WORSE hard disk.

Step 508: Determine whether the current read-write rate has recovered to a specified read-write rate threshold.

Here, the electronic device determines whether the current read-write rate has recovered to fall within the specified read-write rate threshold. If so, the adjustment is completed and the PLV risk is resolved. If not, the process returns to step 504 to continue. In this way, the embodiments of the disclosure avoid a loss of fan function and improve heat dissipation capacity by adjusting the fan rotation speed in real time.

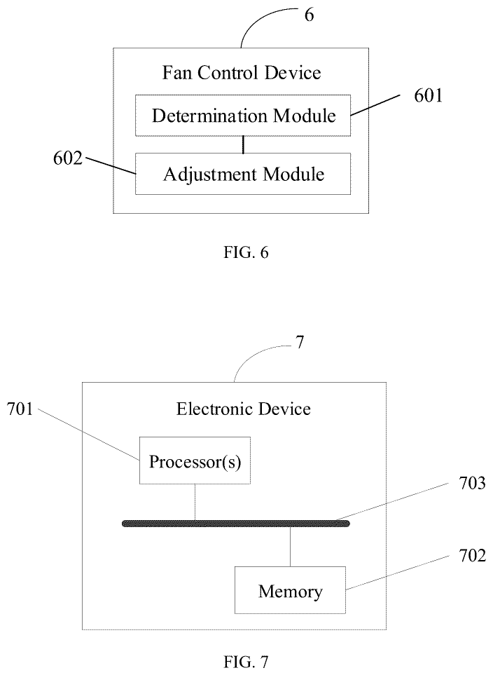

Embodiments of the disclosure provide a fan control device, which may be configured to implement a fan control method provided in the embodiments corresponding to FIGS. 1 to 4. As shown in FIG. 6, the fan control device 6 includes the following units.

A determination module 601, which is configured to determine a target fan that causes the storage read-write performance of the electronic device to degrade based on the relationship between hard disks and fans in the electronic device, where the target fan is one or part of all the fans.

A adjustment module 602, which is configured to adjust the actual rotation speed of the to-be-adjusted fan so that the characteristic parameters of each component in the electronic device meet the performance benchmark, where the to-be-adjusted fan is determined based on the target fan, where the characteristic parameters of each component meeting the performance benchmark includes: the temperature of each component meeting the corresponding predefined temperature guideline, and/or, the storage read-write performance of the electronic device meeting the read-write performance benchmark, and each component including a hard disk.

In some embodiments, the determination module 601 is also configured to determine a target hard disk with reduced read-write performance based on one or more of a predefined relationship between the target hard disk and the fans, a positional relationship between the target hard disk and the fans, and a relationship between the fan rotation speed adjustment and the read-write performance change of the target hard disk, and determine a target fan corresponding to the target hard disk, where the target fan includes one or more fans.

In some embodiments, the determination module 601 is also configured to determine that a fan having a predefined corresponding relationship with the target hard disk is the target fan; obtain a distance between the target hard disk and each fan, and determine that a fan whose distance is less than the first distance is the target fan; and sequentially adjust the actual rotation speed of each fan in turn, and obtain a monitoring result of whether the read-write performance of the target hard disk has changed, and when the monitoring result indicates that the read-write performance of the target hard disk has changed, determine that the currently adjusted fan is the target fan.

In some embodiments, the adjustment module 602 is also configured to gradually reduce or increase the actual rotation speed of the target fan with a first step rotation speed; or, obtain a first weight of the target fan, and gradually reduce or increase the actual rotation speed of the target fan based on the first weight, where the weight is determined based on the distance between each fan and the target hard disk, and/or a degree of influence of each fan on the target hard disk, where the target hard disk is a hard disk with degraded storage read-write performance in an electronic device.

In some embodiments, the adjustment module 602 is also configured to gradually reduce or increase the actual rotation speed of the target fan with a first step rotation speed, and gradually increase or reduce the actual rotation speed of the remaining fans with a second step rotation speed, and the first step rotation speed is the same as or different from the second step rotation speed; or, obtain a first weight of the target fan and a second weight of the remaining fans, and based on the first weight, gradually reduce or increase the actual rotation speed of the target fan, and based on the second weight, gradually increase or reduce the actual rotation speed of the remaining fans. Here, the first and second weights are determined based on the distance between each fan and the target hard disk, and/or, the degree of influence of each fan on the target hard disk. The target hard disk is a hard disk with degraded storage read-write performance in an electronic device.

In some embodiments, the adjustment module 602 is also configured to obtain the current temperature of each component after each adjustment of the current rotation speed of the to-be-adjusted fan, where the current rotation speed includes: the actual rotation speed and/or the actual rotation speed after adjustment. When each current temperature does not meet the corresponding predefined temperature guideline, continue to adjust the current rotation speed of the to-be-adjusted fan until the current temperature of each component meets the corresponding predefined temperature guideline.

In some embodiments, the adjustment module 602 is also configured to obtain the current read-write rate of the target hard disk when the current temperature of each component meets the corresponding predefined temperature guideline. The target hard disk is a hard disk with degraded storage read-write performance in the electronic device. If the current read-write rate of the target hard disk does not meet the read-write performance benchmark, continue to adjust the current rotation speed of the to-be-adjusted fan until the current temperature of each component meets the corresponding predefined temperature guideline and the current read-write rate of the target hard disk meets the read-write performance benchmark. Here, the read-write performance includes the read-write rate.

In some embodiments, the characteristic parameters of each component meeting the performance benchmark also include: the sum of the rotation speeds of all fans after adjustment is identical to or close to the sum of the rotation speeds before adjustment.

In some embodiments, the adjustment module 602 is also configured to determine the risk rotation speed range of each fan. Based on the risk rotation speed range, determine a safe rotation speed range corresponding to each fan. Within the safe rotation speed range corresponding to the to-be-adjusted fan, adjust the actual rotation speed of the to-be-adjusted fan so that the characteristic parameters of the components in the electronic device meet the performance benchmarks.

Based on the above embodiments, an electronic device may be configured for a fan control method provided in the embodiments corresponding to FIGS. 1 to 4. As shown in FIG. 7, the electronic device 7 (the electronic device 7 in FIG. 7 may correspond to the fan control device 6 in FIG. 6) includes a processor 701, a memory 702 and a communication bus 703.

The communication bus 703 is configured to realize the communication connection between the processor 701 and the memory 702.

The fan control program stored in the memory 702 may implement the following steps.

Based on a relationship between hard disks and fans in the electronic device, determine a target fan that causes the storage read-write performance of the electronic device to degrade, where the target fan is one or part of all the fans.

Adjust the actual rotation speed of the to-be-adjusted fan so that the characteristic parameters of each component in the electronic device meet the performance benchmark. Here, the to-be-adjusted fan is determined based on the target fan. The characteristic parameters of each component meet the performance benchmark include: the temperature of each component meets the corresponding predefined temperature guideline, and/or, the storage read-write performance of the electronic device meets the read-write performance benchmark. Each component disclosed herein may refer to a hard disk.

The methods provided in the embodiments of the disclosure may be directly embodied as a combination of software modules executed by the processor 701. The software module may be located in a storage medium, and the storage medium is located in the memory 702. The processor 701 reads the executable instructions included in the software module in the memory 702, and completes the methods provided in the embodiments of the disclosure in combination with the necessary hardware.

As an example, the processor 701 may be an integrated circuit chip with signal processing capabilities, such as a general-purpose processor, a digital signal processor (DSP), or other programmable logic devices, discrete gate or transistor logic devices, discrete hardware components, etc., where the general-purpose processor may be a microprocessor or any conventional processor, etc.

It should be noted that the specific implementation process of the steps executed by the processor in embodiments disclosed herein may refer to the implementation process of the fan control methods provided in the embodiments corresponding to FIGS. 1 to 4, and will not be repeated here.

Embodiments of the disclosure provide a storage medium storing a computer program. When the computer program is executed by at least one processor, the implementation process of the fan control methods provided in the embodiments corresponding to FIGS. 1 to 4 is implemented, which will not be repeated here.

Embodiments of the disclosure provide a computer program product, including a computer program or instructions. When the computer program or instructions are executed by a processor, the implementation process of the fan control methods provided in the embodiments corresponding to FIGS. 1 to 4 is implemented, which will not be repeated here.

The embodiments of the disclosure provide a fan control method and an electronic device, based on the relationship between hard disks and fans in the electronic device, a target fan that causes the storage read-write performance of the electronic device to degrade is determined. The target fan is one or part of all the fans. The actual rotation speed of the to-be-adjusted fan is adjusted so that the characteristic parameters of each component in the electronic device meet the performance benchmark, where the to-be-adjusted fan is determined based on the target fan. The characteristic parameters of each component meet the performance benchmark including: the temperature of each component meets the corresponding predefined temperature guideline, and/or, the storage read-write performance of the electronic device meets the read-write performance benchmark. The referred each component includes a hard disk. In this way, the target fan that causes the storage read-write performance to degrade is determined based on the relationship between hard disks and fans. Further, the rotation speed of the target fan is finely adjusted to avoid overcooling, meet the heat dissipation requirements, and/or reduce the physical vibration interference to the hard disk, which may effectively improve the read-write speed and data transmission efficiency of the hard disk, and ensure that the performance of the storage subsystem meets or exceeds the expected standards. This is crucial for applications that rely on high-speed data processing. Further, the fine adjustment based on the relationship between hard disks and fans not only solves the problem of storage read-write performance degradation, but also improves the overall performance of the electronic device from multiple aspects, and achieves a more efficient, stable and environmentally friendly operating state.

Those skilled in the art will appreciate that the embodiments of the disclosure may be provided as methods, systems, or computer program products. Therefore, the disclosure may take the form of hardware embodiments, software embodiments, or embodiments combining software and hardware. Moreover, the disclosure may take the form of a computer program product implemented on one or more computer-usable storage media (including but not limited to disk storage and optical storage, etc.) containing computer-usable program codes.

The present disclosure is described with reference to the flowcharts and/or block diagrams of the methods, devices (systems), and computer program products according to the embodiments of the disclosure. It should be understood that each process and/or block in the flowcharts and/or block diagrams, as well as the combination of the process and/or block in the flowcharts and/or block diagrams may be implemented by computer program instructions. These computer program instructions may be provided to a processor of a general-purpose computer, a special-purpose computer, an embedded processor or other programmable data processing devices to form a machine, so that the instructions executed by the processor of the computer or other programmable data processing devices form a device for implementing the functions specified in one process or multiple processes in the flowcharts and/or one block or multiple blocks in the block diagrams.

These computer program instructions may also be stored in a computer-readable memory that may direct a computer or other programmable data processing devices to work in a specific manner, so that the instructions stored in the computer-readable memory produce a manufactured product including an instruction device that implements the functions specified in one or more processes in the flowcharts and/or one or more blocks in the block diagrams.

These computer program instructions may also be loaded onto a computer or other programmable data processing devices so that a series of operational steps are executed on the computer or other programmable devices to produce a computer-implemented process, whereby the instructions executed on the computer or other programmable devices provide steps for implementing the functions specified in one or more processes in the flowcharts and/or one or more blocks in the block diagrams.

The foregoing description includes merely some specific embodiments of the disclosure and is not intended to limit the protection scope of the disclosure.

What is claimed is:

1. A fan control method, comprising:
based on a relationship between hard disks and fans in an electronic device, determining a target fan that causes a storage read-write performance of the electronic device to degrade, wherein the target fan is one or part of all fans in the electronic device; and
adjusting an actual rotation speed of a to-be-adjusted fan so that characteristic parameters of each component in the electronic device meet a performance benchmark, wherein the to-be-adjusted fan is determined based on the target fan,
wherein the characteristic parameters of each component meeting the performance benchmark include a temperature of each component meeting a corresponding predefined temperature guideline, and/or a storage read-write performance of the electronic device meeting a read-write performance benchmark, and the each component includes a hard disk.

2. The method according to claim 1, wherein determining the target fan that causes the storage read-write performance of the electronic device to degrade based on the relationship between the hard disks and the fans in the electronic device comprises:
identifying a target hard disk with degraded read-write performance; and
determining the target fan corresponding to the target hard disk based on one or more of a predefined relationship between the target hard disk and the fans, a positional relationship between the target hard disk and the fans, and a relationship between fan rotation speed adjustments and changes in a read-write performance of the target hard disk, wherein the target fan includes one or more fans.

3. The method according to claim 2, wherein:
determining the target fan corresponding to the target hard disk based on the predefined relationship between the target hard disk and the fans includes determining a fan having a predefined corresponding relationship with the target hard disk as the target fan;
determining the target fan corresponding to the target hard disk based on the positional relationship between the target hard disk and the fans includes obtaining a distance between the target hard disk and each fan, and determining that a fan whose distance is less than a first distance is the target fan; and
determining the target fan corresponding to the target hard disk based on the relationship between the fan rotation speed adjustments and the changes in the read-write performance of the target hard disk includes sequentially adjusting an actual rotation speed of each fan in turn, and obtaining a monitoring result of whether the read-write performance of the target hard disk has changed, and when the monitoring result indicates that the read-write performance of the target hard disk has changed, determining that a currently adjusted fan is the target fan.

4. The method according to claim 1, wherein adjusting the actual rotation speed of the to-be-adjusted fan comprises:
gradually reducing or increasing an actual rotation speed of the target fan with a first step rotation speed; or,
obtaining a first weight of the target fan, and gradually reducing or increasing the actual rotation speed of the target fan based on the first weight, wherein the first weight is determined based on a distance between each fan and a target hard disk, and/or a degree of influence of each fan on the target hard disk, wherein the target hard disk is a hard disk with degraded storage read-write performance in the electronic device.

5. The method according to claim 1, wherein the to-be-adjusted fan further includes remaining fans among all fans except the target fan, and adjusting the actual rotation speed of the to-be-adjusted fan comprises:
gradually reducing or increasing an actual rotation speed of the target fan with a first step rotation speed, and gradually reducing or increasing actual rotation speeds of the remaining fans with a second step rotation speed, wherein the first step rotation speed is the same as or different from the second step rotation speed; or
obtaining a first weight of the target fan and a second weight of the remaining fans, gradually reducing or increasing the actual rotation speed of the target fan based on the first weight, and gradually increasing or reducing the actual rotation speed of the remaining fans based on the second weight, wherein the first weight and the second weight are determined based on a distance between each fan and a target hard disk, and/or a degree of influence of each fan on the target hard disk, and the target hard disk is a hard disk with degraded storage read-write performance in the electronic device.

6. The method according to claim 1, wherein the actual rotation speed of the to-be-adjusted fan is adjusted once or more times, and the method further comprises:
after each adjustment of a current rotation speed of the to-be-adjusted fan, obtaining a current temperature of each component, wherein the current rotation speed includes the actual rotation speed and/or an actual rotation speed after adjustment; and
when the current temperature of each component does not meet the corresponding predefined temperature guideline, continuing to adjust the current rotation speed of the to-be-adjusted fan until the current temperature of each component meets the corresponding predefined temperature guideline.

7. The method according to claim 6, further comprising:
when the current temperature of each component meets the corresponding predefined temperature guideline, obtaining a current read-write rate of a target hard disk, the target hard disk being a hard disk with degraded storage read-write performance in the electronic device; and
when the current read-write rate of the target hard disk does not meet the read-write performance benchmark, continuing to adjust the current rotation speed of the to-be-adjusted fan until the current temperature of each component meets the corresponding predefined temperature guideline and the current read-write rate of the target hard disk meets the read-write performance benchmark, wherein the read-write performance includes a read-write rate.

8. The method according to claim 1, wherein the characteristic parameters of each component meeting the performance benchmark further comprises: a sum of rotation speeds of all fans after adjustment is identical to or close to a sum of the rotation speeds of all the fans before adjustment.

9. The method according to claim 1, wherein adjusting the actual rotation speed of the to-be-adjusted fan so that the characteristic parameters of each component in the electronic device meet the performance benchmark comprises:
determining a risk rotation speed range of each fan;
determining a safe rotation speed range corresponding to each fan based on the risk rotation speed range; and
adjusting the actual rotation speed of the to-be-adjusted fan within a safe rotation speed range corresponding to the to-be-adjusted fan, so that the characteristic parameters of each component in the electronic device meet the performance benchmark.

10. An electronic device, comprising one or more processors and a memory containing a computer program that, when being executed, causes the one or more processors to perform:
based on a relationship between hard disks and fans in an electronic device, determining a target fan that causes a storage read-write performance of the electronic device to degrade, wherein the target fan is one or part of all fans in the electronic device; and
adjusting an actual rotation speed of a to-be-adjusted fan so that characteristic parameters of each component in the electronic device meet a performance benchmark, wherein the to-be-adjusted fan is determined based on the target fan,
wherein the characteristic parameters of each component meeting the performance benchmark include a temperature of each component meeting a corresponding predefined temperature guideline, and/or a storage read-write performance of the electronic device meeting a read-write performance benchmark, and the each component includes a hard disk.

11. The electronic device according to claim 10, wherein the one or more processors are further caused to perform:
identifying a target hard disk with degraded read-write performance; and
determining the target fan corresponding to the target hard disk based on one or more of a predefined relationship between the target hard disk and the fans, a positional relationship between the target hard disk and the fans, and a relationship between fan rotation speed adjustments and changes in a read-write performance of the target hard disk, wherein the target fan includes one or more fans.

12. The electronic device according to claim 11, wherein the one or more processors are further caused to perform:
determining a fan having a predefined corresponding relationship with the target hard disk as the target fan;
obtaining a distance between the target hard disk and each fan, and determining that a fan whose distance is less than a first distance is the target fan; and
sequentially adjusting an actual rotation speed of each fan in turn, and obtaining a monitoring result of whether the read-write performance of the target hard disk has changed, and when the monitoring result indicates that the read-write performance of the target hard disk has changed, determining that a currently adjusted fan is the target fan.

13. The electronic device according to claim 10, wherein the one or more processors are further caused to perform:
gradually reducing or increasing an actual rotation speed of the target fan with a first step rotation speed; or,
obtaining a first weight of the target fan, and gradually reducing or increasing the actual rotation speed of the target fan based on the first weight, wherein the first weight is determined based on a distance between each fan and a target hard disk, and/or a degree of influence of each fan on the target hard disk, wherein the target hard disk is a hard disk with degraded storage read-write performance in the electronic device.

14. The electronic device according to claim 10, wherein the one or more processors are further caused to perform:
gradually reducing or increasing an actual rotation speed of the target fan with a first step rotation speed, and gradually reducing or increasing actual rotation speeds of the remaining fans with a second step rotation speed, wherein the first step rotation speed is the same as or different from the second step rotation speed; or
obtaining a first weight of the target fan and a second weight of the remaining fans, gradually reducing or increasing the actual rotation speed of the target fan based on the first weight, and gradually increasing or reducing the actual rotation speed of the remaining fans based on the second weight, wherein the first weight and the second weight are determined based on a distance between each fan and a target hard disk, and/or a degree of influence of each fan on the target hard disk, and the target hard disk is a hard disk with degraded storage read-write performance in the electronic device.

15. The electronic device according to claim 10, wherein the one or more processors are further caused to perform:
after each adjustment of a current rotation speed of the to-be-adjusted fan, obtaining a current temperature of each component, wherein the current rotation speed includes the actual rotation speed and/or an actual rotation speed after adjustment; and
when the current temperature of each component does not meet the corresponding predefined temperature guideline, continuing to adjust the current rotation speed of the to-be-adjusted fan until the current temperature of each component meets the corresponding predefined temperature guideline.

16. The electronic device according to claim 15, wherein the one or more processors are further caused to perform:
when the current temperature of each component meets the corresponding predefined temperature guideline, obtaining a current read-write rate of a target hard disk, the target hard disk being a hard disk with degraded storage read-write performance in the electronic device; and
when the current read-write rate of the target hard disk does not meet the read-write performance benchmark, continuing to adjust the current rotation speed of the to-be-adjusted fan until the current temperature of each component meets the corresponding predefined temperature guideline and the current read-write rate of the target hard disk meets the read-write performance benchmark, wherein the read-write performance includes a read-write rate.

17. The electronic device according to claim 10, wherein the characteristic parameters of each component meeting the performance benchmark further comprises: a sum of rotation speeds of all fans after adjustment is identical to or close to a sum of the rotation speeds of all the fans before adjustment.

18. The electronic device according to claim 10, wherein the one or more processors are further caused to perform:
determining a risk rotation speed range of each fan;
determining a safe rotation speed range corresponding to each fan based on the risk rotation speed range; and
adjusting the actual rotation speed of the to-be-adjusted fan within a safe rotation speed range corresponding to the to-be-adjusted fan, so that the characteristic parameters of each component in the electronic device meet the performance benchmark.

19. A non-transitory computer readable storage medium containing a computer program that, when being executed, causes at least one processor to perform:
based on a relationship between hard disks and fans in an electronic device, determining a target fan that causes a storage read-write performance of the electronic device to degrade, wherein the target fan is one or part of all fans in the electronic device; and
adjusting an actual rotation speed of a to-be-adjusted fan so that characteristic parameters of each component in the electronic device meet a performance benchmark, wherein the to-be-adjusted fan is determined based on the target fan,
wherein the characteristic parameters of each component meeting the performance benchmark include a temperature of each component meeting a corresponding predefined temperature guideline, and/or a storage read-write performance of the electronic device meeting a read-write performance benchmark, and the each component includes a hard disk.

20. The non-transitory computer-readable storage medium according to claim 19, wherein the at least one processor is further caused to perform:
identifying a target hard disk with degraded read-write performance; and
determining the target fan corresponding to the target hard disk based on one or more of a predefined relationship between the target hard disk and the fans, a positional relationship between the target hard disk and the fans, and a relationship between fan rotation speed adjustments and changes in a read-write performance of the target hard disk, wherein the target fan includes one or more fans.
